(19) United States
(12) Patent Application Publication
(10) Pub. No.: US 2011/0107677 A1
(43) Pub. Date: May 12, 2011

(54) OSCILLATING-MOUNT SPLIT-HINGE DEVICE DESIGNED TO BE FITTED ON A VERY HEAVY DOOR, AND VERY HEAVY DOOR EQUIPPED WITH SUCH A DEVICE

(75) Inventor: Christian BOURGET, MEZIERES-EN-DROUAIS (FR)

(73) Assignee: BAUMERT, SCHAEFFERSHEIM (FR)

(21) Appl. No.: 12/945,208

(22) Filed: Nov. 12, 2010

(30) Foreign Application Priority Data
Nov. 12, 2009 (FR) 0957975

(51) Int. Cl. E05D 11/04; E06B 3/40

(52) U.S. Cl. 49/399; 16/275

(57) ABSTRACT

An oscillating-mount split-hinge device designed to be fitted on a very heavy door that includes at least one flap or panel mounted to pivot on a frame, includes at least one lower split-hinge for supporting at least the bulk of the load of the flap of the door and at least one upper split-hinge to form an anti-tilting holding point and axial guide of the flap, whereby each lower or upper split-hinge, includes a stationary split-hinge part integral with the frame and a movable split-hinge part, respectively, integral with the flap, and a pivoting shaft integral with the frame, or the flap, to guide in rotation the movable split-hinge part relative to the stationary split-hinge part around the pivoting shaft, by insertion of roller bearing elements that can allow an angular lack of coaxiality on the stationary split-hinge part relative to the movable split-hinge part of each so-called lower split-hinge and/or upper split-hinge.

This invention relates to the field of very heavy doors allowing in particular access to a closed space in a hostile environment and more particularly a closed space in a nuclear power plant, and it has as its object an oscillating-mount split-hinge device that is designed to be fitted on such very heavy doors. It also has as its object such a very heavy door that is equipped with said split-hinge device.

It is known that a conventional door split-hinge that comprises a flap that pivots around a vertical axis consists of, on the one hand, two split-hinge parts—one of which, stationary, is mounted on the frame, and the other, movable, is mounted on said pivoting flap—and, on the other hand, a pivoting shaft—generally integral with the frame or, if necessary, the flap, which makes it possible to guide the unit in rotation by sliding, around said pivoting shaft, one of said split-hinge parts relative to the other.

The existing split-hinges are fitted on all types of doors of different weights, but those that are fitted on very heavy doors, weighing several tons, are to support axially significant loads, whose requirements and the actual standards in terms of safety are very high.

This is particularly the case of very heavy doors that are installed, using cranes, in hostile environments such as nuclear power plants and in particular in the building of said power plants that contains the nuclear reactor.

Split-hinge systems that are fitted on such very heavy doors that generally comprise a lower split-hinge that is designed to support at least the bulk of the load of the flap of the door and an upper split-hinge that is designed primarily to form an anti-tilting holding point and axial guide of the flap of said door are already known.

In a split-hinge system of this type, the lower split-hinge and the upper split-hinge each comprise a respectively lower and an upper pivoting shaft, making it possible to guide in rotation the respectively lower and upper movable split-hinge part relative to the respectively lower and upper stationary split-hinge part around said pivoting shaft, and this is done by insertion of roller bearing means.

Furthermore, the pivoting of the flap of the door for its opening or closing is done by a mechanical crank system or by a power unit, whose motor is generally attached to the frame and drives a rotary shaft that is integral with the flap and in particular the movable split-hinge part of the lower split-hinge.

It has been noted, however, that when such a very heavy door is opened, bending frequently occurs at the frame, producing an offsetting movement of the two respectively upper and lower split-hinges, which generates considerable friction at one and/or the other of the axes of said split-hinges, which has the effect of causing jamming between the axis in question and the corresponding split-hinge, and an increased pivoting force during the closing or opening movements of the pivoting flap of said door.

However, if the opening or the closing of the flaps of such very heavy doors can nevertheless be performed, even in the offset state, owing to the use of high-power power units to counteract the friction generated by said state, this goes against current economic requirements in terms of reducing production costs of such doors and lowering the consumption of said power units, which can be accomplished only by the use of power units of limited power.

The document FR 829 875 has as its object a joint device for the panel of a door by means of a pivot upright that consists of a metal pipe that is engaged at its lower end on a pivot that forms a step bearing that is sealed in the ground and at its upper end on a pivot, whereby said ends are locked respectively by an upper head and a lower head, while a spherical ball is inserted between the bottom of the lower head and the upper surface of the lower pivot.

However, this type of device that comprises a metal pipe, forming a hinge, requiring a sealing of its lower end in the ground by means of a step bearing by means of in particular a spherical ball, does not allow a sufficiently effective operation of the joint for an application to a very heavy door, in particular a door that is used in a nuclear power unit. In addition, the very heavy doors that are used in the nuclear field should be able to resist or withstand an earthquake, which does not allow a joint device such as the one that is described in the above-mentioned document, fitted on such a door. Actually, in this type of device, during an earthquake that produces combined movements of the door in several directions, the ball leaves its housing, thereby affecting the behavior and the resistance of the door during these sudden movements.

This invention has as its object to eliminate these drawbacks by proposing an oscillating-mount split-hinge device for a very heavy door that makes it possible to prevent, in the offset state, all parasitic friction of the shafts of the split-hinges during opening and closing movements of the flap of said door, whether the door is equipped with a power unit, in particular of limited power, or with a mechanical opening system, for example using a crank, while imparting to the door effective behavior and resistance, in particular in the case of an earthquake.

For this purpose, the oscillating-mount split-hinge device is designed to be fitted on a very heavy door that consists of at least one flap or panel that is mounted to pivot on a frame, comprising at least one lower split-hinge that is designed in particular to support at least the bulk of the load of the flap of said door and at least one upper split-hinge that is designed in particular to form an anti-tilting holding point and axial guide of said flap, whereby each lower or upper split-hinge, on the one hand, consists of a stationary split-hinge part that is respectively integral with the frame, and a movable split-hinge part that is respectively integral with the flap, and, on the other hand, comprising a pivoting shaft that is integral with said frame, or, if necessary, flap, making it possible to guide in rotation the movable split-hinge part relative to the stationary split-hinge part around said pivoting shaft, and this is done by insertion of roller bearing means, and it is characterized essentially in that:
The guiding in rotation of the movable split-hinge part relative to the stationary split-hinge part around the pivoting shaft of each lower split-hinge is done by insertion of an axial superposition of at least one ball roller bearing that is designed to support primarily radial loads and at least one ball stop designed to support primarily axial loads, whereby said roller bearing means are able to allow an angular lack of coaxiality (a) on the part of the stationary split-hinge part relative to the movable split-hinge part of each so-called lower split-hinge, and
The guiding in rotation of the movable split-hinge part relative to the stationary split-hinge part around the pivoting shaft of each upper split-hinge is done by insertion of a superposition of at least one ball roller bearing that is designed to support primarily the radial loads and is able to allow an angular lack of coaxiality of the stationary split-hinge part relative to the movable split-hinge part of each so-called upper split-hinge.

This invention also has as its object a very heavy door that consists of at least one flap that is mounted to pivot on a frame and that makes possible more particularly the access to a closed space of a hostile environment such as a nuclear power plant and that is characterized in that it comprises a split-hinge device according to this invention.

The invention will be better understood using the description below, which relates to a preferred embodiment, provided by way of nonlimiting example and explained with reference to the accompanying diagrammatic drawings, in which:

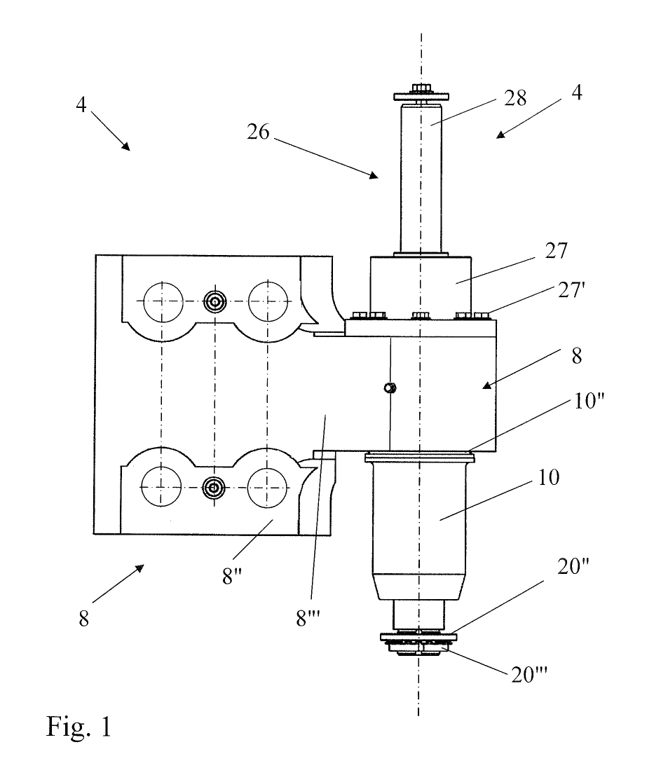

FIG. 1 shows a profile view of a lower split-hinge of the split-hinge device according to this invention in a preferred embodiment,

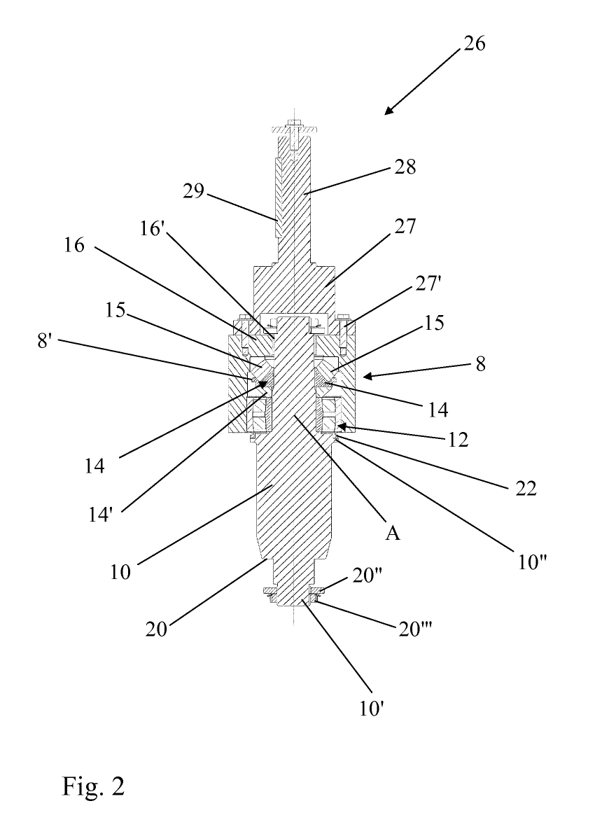

FIG. 2 shows a longitudinal cutaway view of the part of the split-hinge, represented in FIG. 1, through which the corresponding pivoting shaft passes,

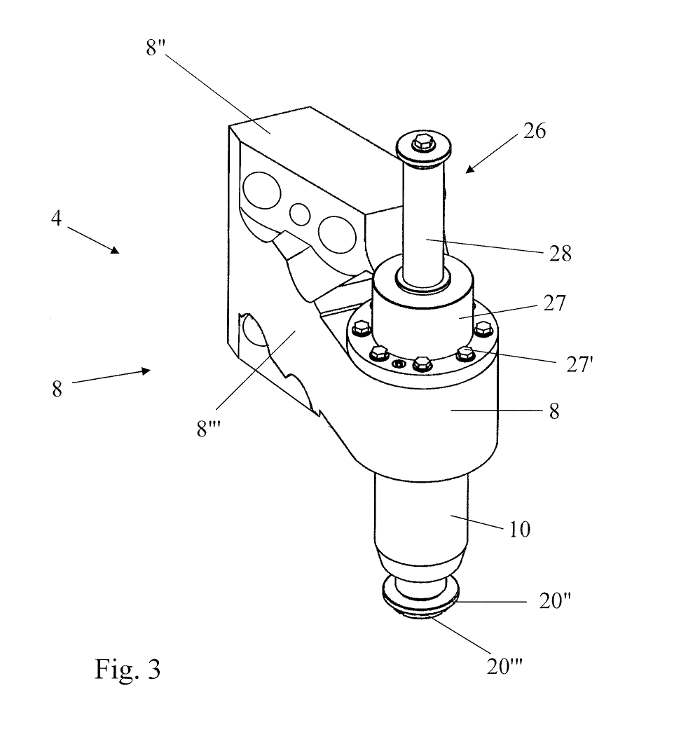

FIG. 3 shows a top ¾ perspective view of the lower split-hinge that is represented in FIG. 1,

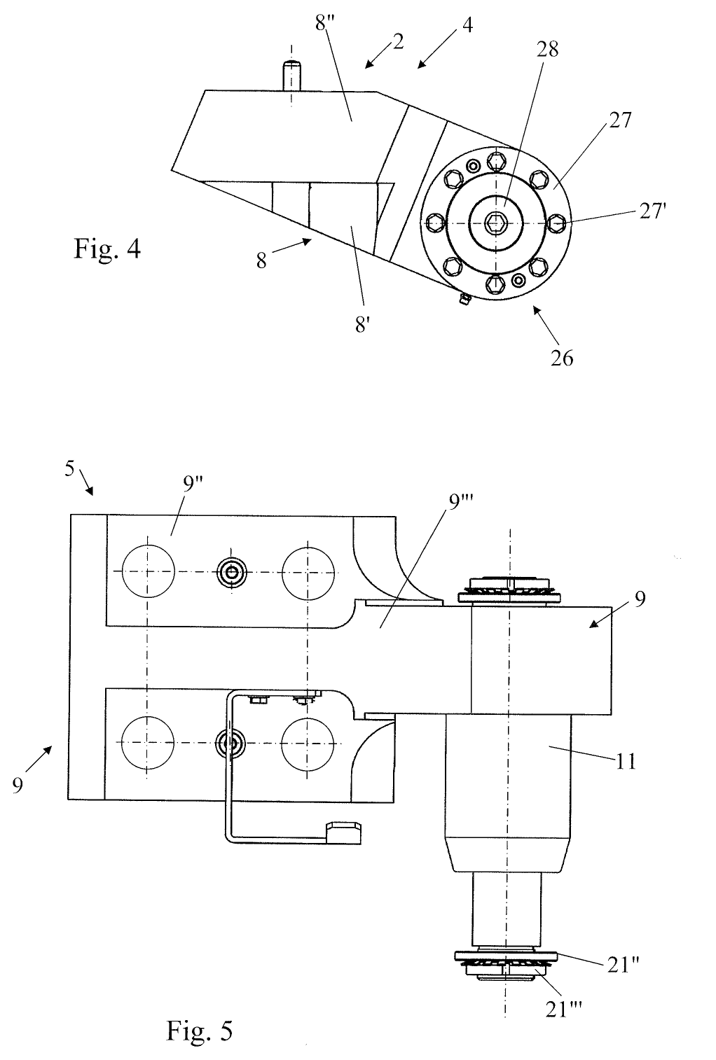

FIG. 4 represents a top view of the lower split-hinge that is represented in FIG. 1,

FIG. 5 represents a profile view of an upper split-hinge of the split-hinge device according to this invention in a preferred embodiment,

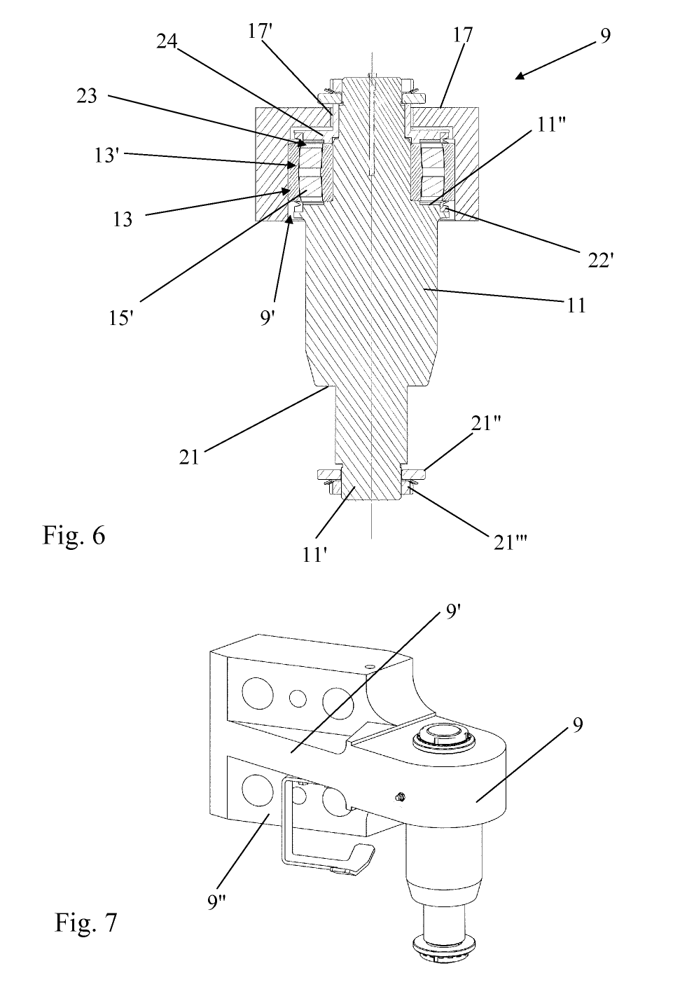

FIG. 6 shows a longitudinal cutaway view of the part of the split-hinge, represented in FIG. 5, through which the corresponding pivoting shaft passes,

FIG. 7 shows a ¾ perspective view of the upper split-hinge that is represented in FIG. 5,

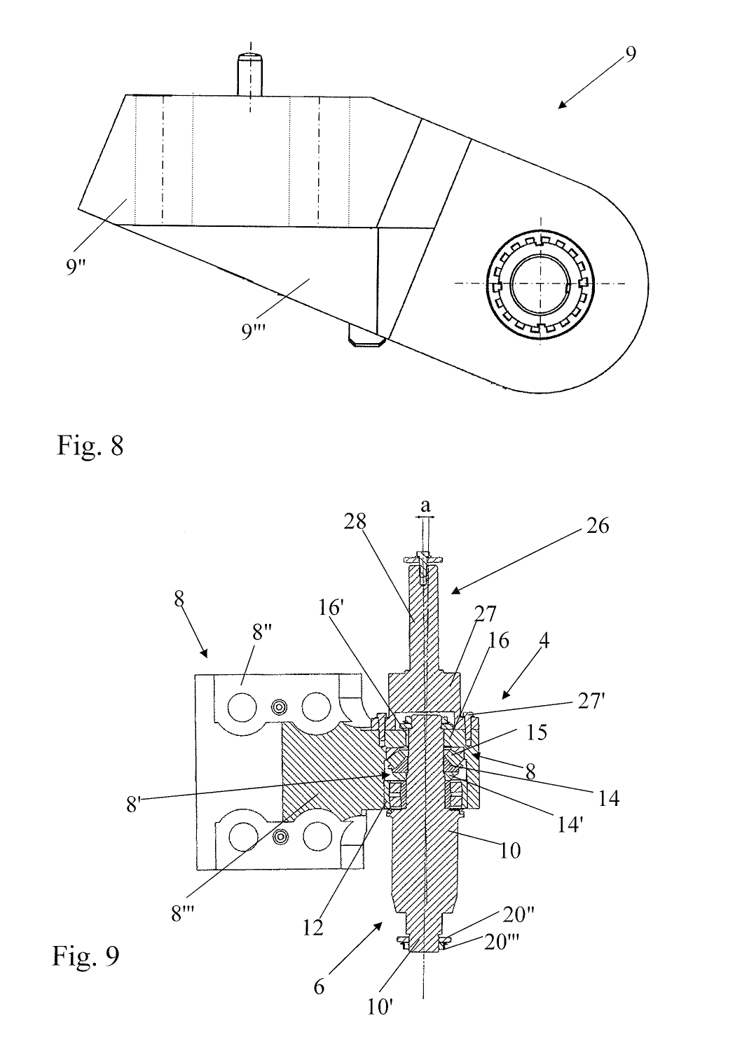

FIG. 8 represents a top view of the lower split-hinge that is represented in FIG. 1,

FIG. 9 represents a longitudinal cutaway view of the lower split-hinge that is represented in FIG. 1 in the offset state,

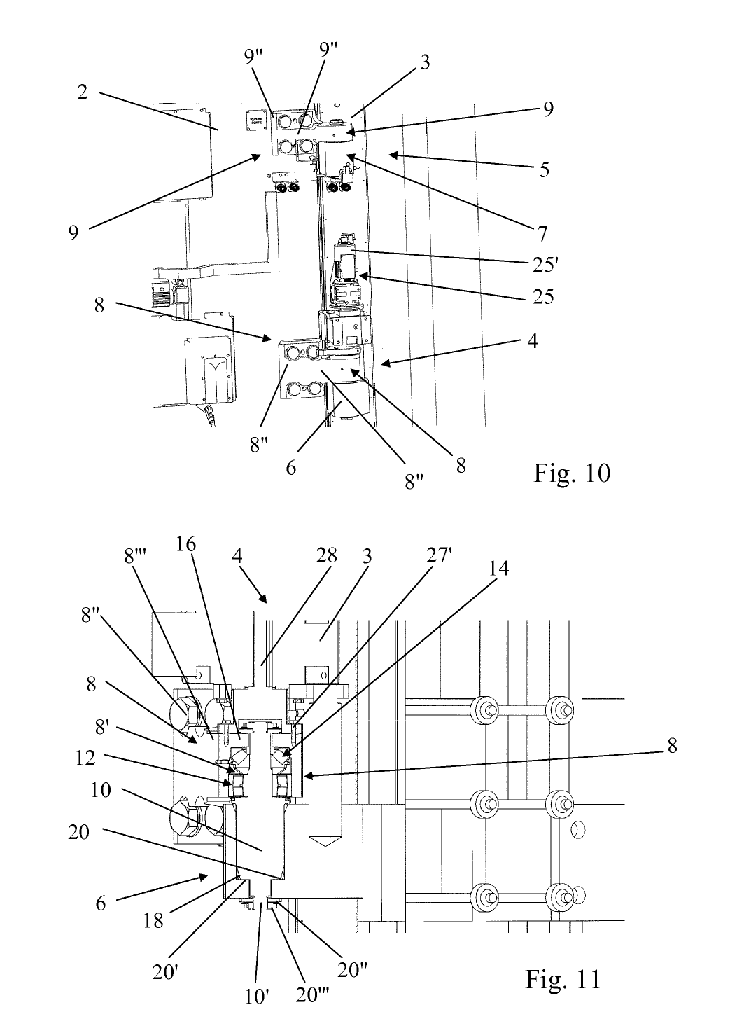

FIG. 10 is a perspective view of the mounting of two respectively lower and upper split-hinges, represented respectively in FIG. 1 and in FIG. 5, mounted on a very heavy door according to this invention,

FIG. 11 is a perspective view along a longitudinal cutaway of the lower split-hinge that is represented in FIG. 1 and mounted on a very heavy door according to this invention,

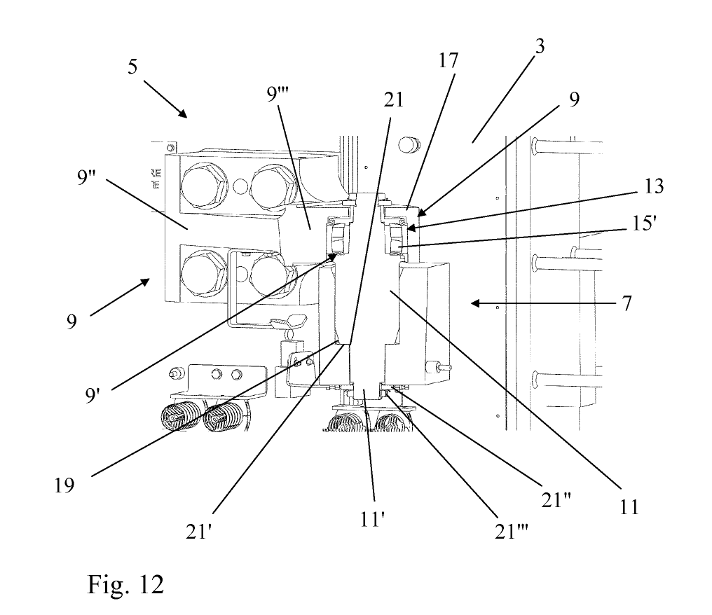

FIG. 12 is a perspective view along a longitudinal cutaway of the upper split-hinge represented in FIG. 5 and mounted on a very heavy door according to this invention.

The figures show an oscillating-mount split-hinge device that is designed to be fitted on a very heavy door 1 that consists of at least one flap or panel 2 that is mounted to pivot on a frame 3 and that makes possible more particularly the access to a closed space of a hostile environment such as a nuclear power plant, whereby said device comprises at least one lower split-hinge 4 that is designed in particular to support at least the bulk of the load of the flap 2 of said door 1 and at least one upper split-hinge 5 that is designed in particular to form an anti-tilting holding point and axial guide of said flap 2, whereby each so-called lower split-hinge 4, or upper split-hinge 5, on the one hand, consists of a stationary split-hinge part 6, or 7, that is integral with the frame 3 and a movable split-hinge part 8, or 9, that is integral with the flap 2, and, on the other hand, comprising a pivoting shaft 10, or 11, that is integral with said frame 3, or, if necessary, the flap 2, making it possible to guide in rotation the movable split-hinge part 8, or 9, relative to the stationary split-hinge part 6, or 7, around said pivoting shaft 10, or 11, and this is done by insertion of roller bearing means 12, 13, 14.

According to this invention, the guiding in rotation of the movable split-hinge part 8 relative to the stationary split-hinge part 6 around the pivoting shaft 10 of each lower split-hinge 4 is done by insertion of an axial superposition of at least one ball roller bearing 12 that is designed to support primarily radial loads and at least one ball stop 14 that is designed to support primarily the axial loads, whereby said roller bearing means 12 and 14 are able to allow an angular lack of coaxiality (a) on the part of the stationary split-hinge 6 relative to the movable split-hinge part (8) of each so-called lower split-hinge 4. In addition, the guiding in rotation of the movable split-hinge part 9 relative to the stationary split-hinge part 7 around the pivoting shaft 11 of each upper split-hinge 5 is done by insertion of a superposition of at least one ball roller bearing 13 that is designed to support primarily the radial loads and is able to allow an angular lack of coaxiality on the part of the stationary split-hinge 7 relative to the movable split-hinge part 9 of each so-called upper split-hinge 5.

If reference is now made to FIG. 2, it is possible to see that each lower split-hinge 4 can preferably comprise a ball roller bearing 12 and a ball stop 14, whose application point A of the resultant of the contact actions of the roller bearing elements 15 of said ball stop 14 is eccentric relative to its median plane. The ball stop 14 is advantageously combined, in a mated way, with said ball roller bearing 12 in such a way that said application point A corresponds essentially to the pivoting center of said ball roller bearing 12. In addition, the axial spacing between said ball roller bearing 12 and said ball stop 14 can preferably be adjusted by means of an adjustment brace 14′ through which the lower pivoting shaft 10 passes axially and is inserted between said stop 14 and said ball roller bearing 12.

Preferably, the movable split-hinge part 8, or 9, of each lower split-hinge 4 or upper split-hinge 5, can be attached to the flap 2 and can comprise a hub 8′, or 9′, designed to accommodate the corresponding pivoting shaft 10, or 11, while the stationary split-hinge part 6, or 7, of each lower split-hinge 4, or upper split-hinge 5, preferably has a hinge shape that carries said pivoting shaft 10, or 11 (FIG. 11 and FIG. 12).

In this case, the pivoting shaft 10 of each lower split-hinge 4 can be mounted to rotate freely in the corresponding hub 8′ by successively passing through, from the base of said hub 8′, the ball roller bearing 12, the adjustment brace 14′, the ball stop 14, and a plain bearing 16 (FIG. 2 and FIG. 9). The latter forms a pivot connection while preserving play 16′ between said lower pivoting shaft 10 and the inside sliding surface of said plain bearing 16, making possible the angular offset (a) of said lower pivoting shaft 10 within the angular limits that are imposed by said ball roller bearing 12 and said ball stop 14 that is combined with the latter, and more particularly within angular limits encompassed between approximately 1 and 2 degrees, preferably between 1.2 and 1.5 degrees, and more preferably between 1.25 and 1.30 degrees, as can be seen in FIG. 9.

Always in this case, as can be seen in FIG. 6, each upper split-hinge 5 can preferably comprise a ball roller bearing 13, and the pivoting shaft 11 of each so-called upper split-hinge 5 can be mounted to rotate freely in the corresponding hub 9′ by successively passing through, from the base of said hub 9′, said ball roller bearing 13 and a plain bearing 17 forming a pivot connection that preserves play 17′ that allows the offsetting, not shown, of said pivoting shaft 11 within the angular limits that are imposed by said ball roller bearing 13, and more particularly within angular limits of between approximately 1 and 2 degrees, preferably between 1.2 and 1.5 degrees, and more preferably between 1.25 and 1.30 degrees.

The stationary split-hinge part 6, or 7, of each lower split-hinge 4, or upper split-hinge 5, can consist of a hollow piece in the form of an eyelet that is attached to the frame 3 and that comprises a receiving cavity 18, or 19, of an axis that is essentially combined with the axis of rotation of the flap 2 (FIG. 10).

Thus, as can be seen in FIG. 11 and in FIG. 12, the pivoting shaft 10, or 11, of each lower split-hinge 4, or upper split-hinge 5, can be engaged, for example, on the one hand, by its low part, in said corresponding receiving cavity 18, or 19, in which it is held and centered axially essentially on said axis of rotation in an essentially vertical position, with axial and anti-rotational locking, by means of a casing connection between said pivoting shaft 10, or 11, and the corresponding receiving cavity 18, or 19, and, on the other hand, by its top part, in the corresponding hub 8′, or 9′, of the movable split-hinge part 8, or 9.

This invention can ensure that the pivoting shaft 10, or 11, or each lower split-hinge 4 or upper split-hinge 5, ends at one of its ends that extends downward beyond the corresponding receiving cavity 18, or 19, by an end fitting 10′, or 11′, preferably threaded on its outside surface, and that the casing connection can consist of, on the one hand, a first shoulder 20, or 21, made in said corresponding pivoting shaft 10, or 11, that mates with a second shoulder 20′, or 21′, made in the inside wall of the receiving cavity 18, or 19, so as to prevent the axial movement of the lower pivoting shaft 10, or upper pivoting shaft 11, downward, and, on the other hand, a stop washer 20″, or 21″, placed around said end fitting and being held, with locking, in a stop position by means of a nut 20′″, or 21′″, screwed onto the threaded part of said end fitting 10′, or 11′, so as to prevent the axial movement of said pivoting shaft 10, or 11, upward and starting from its disengagement from the corresponding hub 8′, or 9′.

If reference is now made to FIG. 2 and to FIG. 6, it is possible to see that the ball roller bearing 13 of each upper split-hinge 5, or the ball roller bearing 12 and ball stop 14 system of each lower split-hinge 4, is preferably locked axially in the hub 8′, or 9′, of the corresponding movable split-hinge part 8, or 9, between, on the one hand, a shoulder 10″, or 11″, made in the outside surface of the pivoting shaft 10, or 11, by means of an annular sealing joint 22, or 22′, and, on the other hand, the corresponding plain bearing 16, or 17.

In addition, each upper split-hinge 5 can comprise an intermediate piece 24, for example, in the form of a sleeve through which the pivoting shaft 11, corresponding to the corresponding level of the plain bearing 17, passes, while the base of said intermediate piece 24 can be enlarged by extending radially to cover tightly, for example by means of an annular joint 23, the cage 13′ of the ball roller bearing 13. In addition, said intermediate piece 24 can advantageously be installed in particular after having filled said cage with lubricating grease of the roller bearing elements 15′ of said ball roller bearing 13 (FIG. 6).

Preferably, the ball roller bearing(s) 12, 13 are advantageously ball roller bearings on rollers, preferably conical rollers, on balls or on needles, and preferably ball roller bearings on rollers with two rows of preferably conical rollers, able to support heavy loads, and the ball stop(s) 14 is/are advantageously ball stops on rollers that can support heavy axial loads but also relatively large radial loads.

Preferably, a lower split-hinge 4 can comprise a ball roller bearing 12 on rollers with two rows of conical rollers and one ball stop on rollers, while an upper split-hinge 5 can comprise a ball roller bearing 13 on rollers with two rows of conical rollers, as can be seen in particular in FIG. 2 and in FIG. 6.

This invention can ensure that the pivoting of the flap 2 of the very heavy door for its opening or closing is done by means of a power unit 25, preferably with limited power, comprising a motor 25′, such as, for example, a geared motor, designed to drive, for example by means of a drive key 29, a drive shaft 26 that is integral with said flap 2 and preferably the movable split-hinge part 8 of each lower split-hinge 4, as can be seen in FIG. 2 and in FIG. 10.

It is also possible to see in the figures that the movable split-hinge part 8, or 9, of each lower split-hinge 4, or upper split-hinge 5, can consist of a support plate 8″, or 9″, designed to be attached in a known manner, for example by screwing, on the flap 2 and extending via an arm 8′″, or 9′″, carrying at its free end the part that forms the hub 8′, or 9′, and that said arm 8′″, or 9′″, can extend advantageously by moving away from the plane of the flap 2 so as to create a space or sufficient disengagement from said flap 2 to house and implement the power unit 25, preferably at each lower split-hinge 4. The drive shaft 26 of the flap 2 that is driven in rotation by the motor 25′ can advantageously constitute an axial extension upward of the hub 8′ of the corresponding movable split-hinge part 8 of each so-called lower split-hinge 4.

This invention can ensure, as can be seen in particular in FIG. 1, FIG. 2, FIG. 3 and FIG. 10, that the drive shaft 26 can preferably consist of a hood 27 with an overall cylindrical shape that can cover, with its enlarged base, the upper surface of the corresponding hub 8′ of the movable split-hinge part 8 of the lower split-hinge 4, on which upper surface said hood 27 is preferably attached by screwing of the screw 27′ and extends axially on its upper part by a drive shaft 28 that comprises—on its outside surface—at least one connection key 29, preferably extending longitudinally on said outside surface, making it possible to link in rotation said drive shaft 28 with the drive means, not shown, of said motor 25, which can be, for example, a drive hub in which at least one key groove that can functionally accommodate the corresponding connection key 29 can be made.

The figures also show a very heavy door 1 according to this invention that consists of at least one flap 2 that is mounted to pivot on a frame 3 and that makes possible more particularly the access to a closed space of a hostile environment such as a nuclear power plant, whereby said door is equipped with a split-hinge device, according to this invention, preferably comprising a lower split-hinge 4 and an upper split-hinge 5.

Of course, the invention is not limited to the embodiment that is described and shown in the accompanying drawings. Modifications are possible, in particular from the standpoint of the composition of various elements or by substitiuton of equivalent techniques, without thereby exceeding the field of protection of the invention.

1. Oscillating-mount split-hinge device that is designed to be fitted on a very heavy door (1) that consists of at least one flap or panel (2) that is mounted to pivot on a frame (3), comprising at least one lower split-hinge (4) that is designed in particular to support at least the bulk of the load of the flap (2) of said door (1) and at least one upper split-hinge (5) that is designed in particular to form an anti-tilting holding point and axial guide of said flap (2), whereby each so-called lower split-hinge (4), or upper split-hinge (5), on the one hand, consists of a stationary split-hinge part (6), or (7), that is integral with the frame (3), or a movable split-hinge part (8), or (9), that is integral with the flap (2), and, on the other hand, comprising a pivoting shaft (10), or (11), that is integral with said frame (3), or, if necessary, flap (2), making it possible to guide in rotation the movable split-hinge part (8), or (9), relative to the stationary split-hinge part (6), or (7), around said pivoting shaft (10), or (11), and this is done by insertion of roller bearing means (12, 13, 14);
device characterized in that:
The guiding in rotation of the movable split-hinge part (8) relative to the stationary split-hinge part (6) around the pivoting shaft (10) of each lower split-hinge (4) is done by insertion of an axial superposition of at least one ball roller bearing (12) that is designed to support primarily radial loads and at least one ball stop (14) designed to support primarily axial loads, whereby said roller bearing means (12) and (14) are able to allow an angular lack of coaxiality (a) on the part of the stationary split-hinge part (6) relative to the movable split-hinge part (8) of each so-called lower split-hinge (4), and
The guiding in rotation of the movable split-hinge part (9) relative to the stationary split-hinge part (7) around the pivoting shaft (11) of each upper split-hinge (5) is done by insertion of a superposition of at least one ball roller bearing (13) that is designed to support primarily the radial loads and is able to allow an angular lack of coaxiality of the stationary split-hinge part (7) relative to the movable split-hinge part (9) of each so-called upper split-hinge (5).

2. Device, according to claim 1, wherein each lower split-hinge (4) comprises a ball roller bearing (12) and a ball stop (14), whose application point (A) of the resultant of the contact actions of the roller bearing elements (15) of said ball stop (14) is eccentric relative to its median plane, and wherein said ball stop (14) is combined, in a mated way, with said ball roller bearing (12) in such a way that said application point (A) corresponds essentially to the pivoting center of said ball roller bearing (12), whereby the axial spacing between the latter and said ball stop (14) is preferably adjusted by means of an adjustment brace (14′) through which the lower pivoting shaft (10) passes axially and is inserted between said ball stop (14) and said ball roller bearing (12).

3. Device, according to claim 2, wherein the movable split-hinge part (8), or (9), of each lower split-hinge (4), or upper split-hinge (5), is attached to the flap (2) and comprises a hub (8′), or (9′), designed to accommodate the corresponding pivoting shaft (10), or (11), while the stationary split-hinge part (6), or (7), of each lower split-hinge (4), or upper split-hinge (5), has a hinge shape that carries said pivoting shaft (10), or (11), and wherein:
The pivoting shaft (10) of each lower split-hinge (4) is mounted to rotate freely in the corresponding lower hub (8′) by successively passing through, from the base of said lower hub (8′), the ball roller bearing (12), the adjustment brace (14′), the ball stop (14), and a plain bearing (16) forming a pivot connection and preserving play (16′) between the corresponding pivoting shaft (10) and the inside sliding surface of said plain bearing (16), making possible the angular offset (a) of said pivoting shaft (10) within the angular limits imposed by said ball roller bearing (12) and said ball stop (14) associated with the latter, and more particularly within angular limits encompassed between approximately 1 and 2 degrees, and more preferably between 1.2 and 1.3 degrees, and
Each upper split-hinge (5) comprises a ball roller bearing (13), and the pivoting shaft (11) of each so-called upper split-hinge (5) is mounted to rotate freely in the corresponding hub (9′) by passing successively, from the base of said upper hub (9′), through the ball roller bearing (13) and a plain bearing (17) that forms a pivot connection that preserves play (17′), making possible the offsetting of said upper pivoting shaft (11) within angular limits imposed by said ball roller bearing (13), and more particularly within the angular limits encompassed between approximately 1 and 2 degrees, and more preferably between 1.2 and 1.3 degrees.

4. Device, according to claim 3, wherein the stationary split-hinge part (6), or (7), of each lower split-hinge (4), or upper split-hinge (5), consists of a hollow piece in the form of an eyelet attached to the frame (3) and comprising a corresponding receiving cavity (18), or (19), with an axis that is essentially combined with the axis of rotation of the flap (2) and wherein the pivoting shaft (10), or (11), of each so-called lower split-hinge (4), or upper split-hinge (5), is engaged, on the one hand, by its low part, in said corresponding receiving cavity (18), or (19), in which it is held and centered axially essentially on said axis of rotation in an essentially vertical position, with axial and anti-rotational locking, by means of a casing connection between said pivoting shaft (10), or (11), and the receiving cavity (18), or (19), and, on the other hand, by its top part, in the corresponding hub (8′), or (9′), of the movable split-hinge part (8), or (9), of each so-called lower split-hinge (4) or upper split-hinge (5).

5. Device, according to claim 4, wherein the pivoting shaft (10), or (11), ends at its lower end, which extends downward beyond the receiving cavity (18), or (19), by an end fitting (10′), or (11′), preferably threaded, and wherein the casing connection consists of, on the one hand, a first shoulder (20), or (21), made in said pivoting shaft (10), or (11), that mates with a second shoulder (20′), or (21′), made in the inside wall of the receiving cavity (18), or (19), so as to prevent the axial movement of the pivoting shaft (10), or (11), downward, and, on the other hand, a stop washer (20″), or (21″), placed around said end fitting and being held, with locking, in a stop position by means of, for example, a nut (20′″), or (21′″), screwed onto the threaded part of said end fitting (10′), or (11′), so as to prevent the axial movement of said pivoting shaft (10), or (11), upward.

6. Device, according to claim 3, wherein the ball roller bearing (13) of each upper split-hinge (5), or the ball roller bearing (12) and ball stop (14) system of each lower split-hinge (4), is locked axially in the corresponding hub (8′), or (9′), of the corresponding movable split-hinge part (8), or (9), between, on the one hand, a shoulder (10″), or (11″), made in the outside surface of the pivoting shaft (10), or (11), by means of an annular sealing joint (22), or (22′), and, on the other hand, the corresponding plain bearing (16), or (17).

7. Device, according to claim 6, wherein each upper split-hinge (5) also comprises an intermediate piece (24) in the form of a sleeve through which the pivoting shaft (11), corresponding to the level of the plain bearing (17), passes, while the base of said intermediate piece (24) is enlarged by extending radially to cover tightly, for example by means of an annular joint (23), the cage (13′) of the ball roller bearing (13).

8. Device,
according to claim 1, wherein the ball roller bearing(s) (12, 13) is/are ball roller bearings on rollers, preferably conical rollers, on balls or on needles, and preferably ball roller bearings on rollers with two rows of conical rollers and wherein the ball stop(s) (14) is/are ball stops on rollers.

9. Device, according to claim 3, wherein the pivoting of the flap (2) of the very heavy door for its opening or closing is done by means of a power unit (25), preferably with limited power, comprising a motor (25′) that is designed to drive a drive shaft (26) that is integral with said flap (2) and preferably the movable split-hinge part (8) of each lower split-hinge (4).

10. Device, according to claim 9, wherein the movable split-hinge part (8), or (9), of each lower split-hinge (4), or upper split-hinge (5), consists of a support plate (8″), or (9″), designed to be attached to the flap (2) and extending by an arm (8′″) that carries the corresponding hub (8′) or (9′), and wherein said arm (8′″) extends by moving away from the plane of the flap (2) so as to create a space or sufficient disengagement from said flap (2) to house and implement the power unit (25), preferably at each lower split-hinge (4), whereby the drive shaft (26) of the flap (2) constitutes an axial extension upward of the hub (8′) of the corresponding movable split-hinge part (8) of each so-called lower split-hinge (4).

11. Device, according to claim 10, wherein said drive shaft (26) consists of a hood (27) with an overall cylindrical shape that can cover, with its enlarged base, the upper surface of the corresponding hub (8′) of the movable split-hinge part (8) of the lower split-hinge (4), on which upper surface said hood (27) is preferably attached by screwing and extends axially on its upper part by a drive shaft (28) that comprises—on its outside surface—at least one connection key (29), making it possible to link in rotation said drive shaft (28) with the drive means of said motor (25′).

12. Very heavy door (1) that consists of at least one flap (2) that is mounted to pivot on a frame (3) and that more particularly allows access to a closed space in a hostile environment such as a nuclear power plant, wherein it is equipped with a split-hinge device according to claim 1, preferably comprising a lower split-hinge (4) and an upper split-hinge (5).

13. Device, according to claim 1, wherein the pivoting of the flap (2) of the very heavy door for its opening or closing is done by means of a power unit (25), preferably with limited power, comprising a motor (25′) that is designed to drive a drive shaft (26) that is integral with said flap (2) and preferably the movable split-hinge part (8) of each lower split-hinge (4).
